(19) United States
(12) Patent Application Publication
(10) Pub. No.: US 2003/0093725 A1
(43) Pub. Date: May 15, 2003

(54) Method and circuit for monitoring microcomputer for onboard electronic control device

(75) Inventor: Seiji Takahashi, Hisai-shi (JP)

Correspondence Address: GREENBLUM & BERNSTEIN, P.L.C., 1950 ROLAND CLARKE PLACE, RESTON, VA, 20191, US

(73) Assignee: Sumitomo (SEI) Brake Systems, Inc., Mie (JP)

(21) Appl. No.: 10/281,998

(22) Filed: Oct. 29, 2002

(30) Foreign Application Priority Data
Nov. 15, 2001 (JP) 2001-349917

(51) Int. Cl. H02H 3/05

(52) U.S. Cl. 714/47

(57) ABSTRACT

A monitoring method and circuit is provided in which the detection of a failure or runaway of a microcomputer for an onboard control device is possible at a high program level and the cost is low. A program for generating data sequence signals D₁ (0, 1, 2 . . . 6, 7) and timing signals T₁ is provided in the microcomputer to be monitored. When they are received by the monitoring circuit, the data sequence signals D₂ are generated in a counter. Simultaneously, it is checked whether the timing signals T₁ coincide with the timing signals T₂ in a counter to detect abnormality. If abnormality is detected in either of the circuits, the determining circuit determines that the microcomputer is abnormal.

### BACKGROUND OF THE INVENTION

This invention relates to a method and a circuit for detecting a failure or runaway of a microcomputer used as an onboard electronic control device for e.g. antilock control of traveling wheels of an automobile.

As such a method, one is known in which watchdog pulses WDP synchronized with the program cycle of various operating programs performed in the microcomputer are outputed from the microcomputer, and an external monitoring circuit (or watchdog circuit) for monitoring the cycle of WDP's is provided to detect a failure. An example in which such an external monitoring circuit is provided to monitor two sets of microcomputers is disclosed in JP 6-119210 (publication 1).

In this detection method, simple signals are monitored. A method of monitoring the contents of processing in a microcomputer instead of monitoring such simple signals is known from JP 8-328885 (publication 2). In this method, a program for detecting a failure is provided in the microcomputer, the same data as in the microcomputer are inputed into a monitoring circuit provided with a circuit for performing the same process as the operating process, and a failure is detected by comparing and tallying the results of the operating process performed in the microcomputer and the monitoring circuit.

As a simpler method than such a method in which a failure is detected by the operating process in the monitoring circuit, a method is disclosed in JP 10-513286 (publication 3) in which data processing results by the operating process in the microcomputer are sent to a monitoring circuit to detect a failure by comparing data words and time intervals corresponding to the data processing results that are stored in the monitoring circuit beforehand.

In the monitoring circuit of the first publication, since the signals monitored are simple, the monitored signals may be outputted as normal signals even if the microcomputer fails or runs away. Thus, the ability to detect a failure is low. But since this monitoring circuit is of a simple structure comprising a counter, timer, flip-flop, etc., the cost is low.

The monitoring circuit of the second publication has the same processing program as the operating process in the microcomputer and monitors whether or not the same operating processing is performed at the level of programs. Thus the failure detecting accuracy and the detecting level are high, so that a failure can be detected more reliably. But because it has a program similar to the control program in the microcomputer, the cost is high.

The monitoring circuit of the third publication is lower in the failure detection level than the second publication, but the cost is lower. Thus, if the signals to be monitored are complicated in order to detect a failure of the microcomputer at a high level, comparison signals produced in the external monitoring circuit also become complicated, so that it is necessary to form it from expensive hardware such as a microprocessor or a memory. This increases the cost.

An object of this invention is to provide a monitoring method and circuit in which the detection of a failure or runaway of a microcomputer for an onboard control device is possible at a high program level and the cost is low.

### SUMMARY OF THE INVENTION

According to this invention, there is provided a method of monitoring a microcomputer for an onboard control device, comprising the steps of generating and outputting data sequence signals D₁ and timing signals T₁ of predetermined intervals in a control program of the microcomputer to be monitored, generating data sequence signals D₂ from the timing signals T₁ in a counter, comparing the data sequence signals D₁ with the data sequence signals D₂ to detect any abnormality of the data sequence signals D₁, and detecting abnormality of the timing signals T₁ by comparing with timing signals T₂ set by a counter, whereby monitoring the microcomputer by detection of abnormality of the data sequence signals and the timing signals.

There is also provided a circuit for monitoring a microcomputer for an onboard control device, comprising a program provided in a control program of the microcomputer to be monitored for generating data sequence signals D₁ and timing signals T₁ of predetermined intervals, a monitoring circuit connected to the microcomputer for detecting a failure or runaway of the microcomputer to transfer the data sequence signals D₁ and the timing signals T₁, the monitoring circuit having a counter for generating data sequence signals D₂ from the timing signals T₁, a first circuit having a comparator for comparing the data sequence signals D₁ with the data sequence signals D₂ to detect abnormality of the data sequence signals D₁, and a second circuit having a counter for detecting abnormality of the timing signals themselves, and an abnormality determining unit for determining abnormality based on the detection signals of the first and second circuits.

According to the method and circuit for monitoring a microcomputer of this invention, abnormality of the microcomputer is detected by means of a simple structure with high abnormality-detecting ability at high program level. In the microcomputer, constant data sequence signals D₁ for confirming the behavior of normal control during normal control action, and timing signals T₁ at predetermined intervals are repeatedly generated and output from the output terminals.

In the monitoring circuit, when these signals are transmitted, the data sequence signals D₂ are generated in the counter based on the timing signals T₁, and with these signals as reference signals, abnormality of the signals D₁ is checked. Simultaneously, the timing signals themselves are checked for their behavior by the counter. If abnormality is detected in the behavior check in both lines, it is determined that abnormality has occurred in the microcomputer.

The data sequence signals D₁ are not simple ON-OFF signals like conventional watchdog signals but signals generated by computing with a program. They are for example signals in which 0, 1, 2 . . . 6, 7 are repeatedly arranged. Thus they are signals having certain complexity.

### BRIEF DESCRIPTION OF THE DRAWINGS

Other features and objects of the present invention will become apparent from the following description made with reference to the accompanying drawings, in which:

FIG. 1 is a block diagram of the monitoring circuit for a microcomputer embodying this invention;

FIG. 2A is a flowchart showing the operation of the microcomputer;

FIG. 2B is a view for explaining the operation of the monitoring circuit;

FIG. 3A is a view for explaining the data sequence signals; and

FIG. 3B is a view explaining the timing signals.

### DETAILED DESCRIPTION OF THE PREFERRED EMBODIMENT

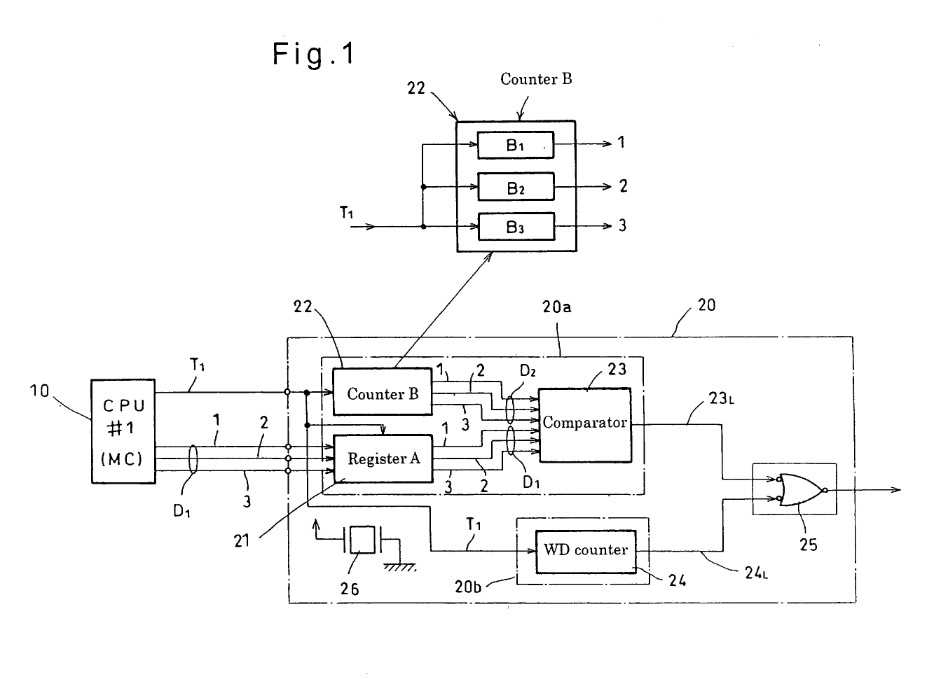

Hereinbelow, one embodiment of this invention will be described with reference to the drawings. FIG. 1 is a block diagram of the monitoring circuit for a microcomputer of the embodiment. In an antilock control device for an automobile, to a microcomputer 10 for carrying out antilock control, a monitoring circuit 20 is connected to check if the microcomputer is operating normally.

With this monitoring circuit 20, the detection level has been improved by use of more complicated signal sequence than in a simple abnormality detecting circuit using conventional watchdog signals. But the circuit is formed of simple hardware elements such as counters and flip-flops to reduce the cost.

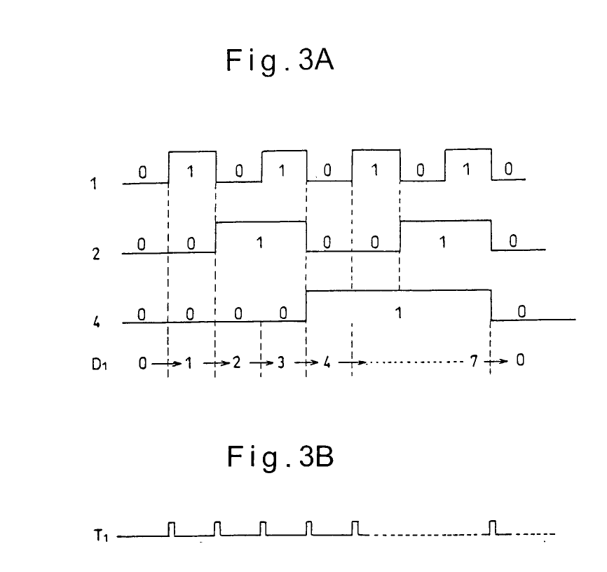

In the microcomputer 10, in a control program for controlling the object to be controlled, a program is provided separately so that the data sequence signals D₁ and timing signals T₁ at predetermined intervals can be generated by a predetermined algorithm A. Data sequence signals D₁ are repetitions of a sequence of numbers in which eight figures are changed like (0→1→2 . . . 6→7) as shown in FIG. 3A. Timing signals T₁ are ON-OFF signals of 1 and 0 which are repeated at predetermined time intervals as shown in FIG. 3B.

The microcomputer 10 has output terminals for the data sequence signals D₁ and timing signals T₁, respectively. For data sequence signals D₁, as shown in FIG. 1, the microcomputer 10 actually has three output terminals. Combination of signals (0, 1) sent to three data lines connected to these output terminals represents each data sequence of 0, 1, 2 ... 7.

The monitoring circuit includes a first monitoring circuit 20a which comprises a counter B 22 for generating data sequence signal D₂ from timing signal T₁, a register A 21 for retaining data sequence signals D₁ from the microcomputer 10, and a comparator 23 for comparing signals D₁ with signals D₂ from the counter 22 and detecting abnormality of the signals D₁. It further includes a second monitoring circuit 20b which has a counter 24 for detecting abnormality of the timing signals T₁ themselves. An abnormality determining circuit 25 receives the detection signals from the two monitoring circuits 20a, 20b to determine abnormality. A clock 26 generates operation reference signals for the monitoring circuit 20.

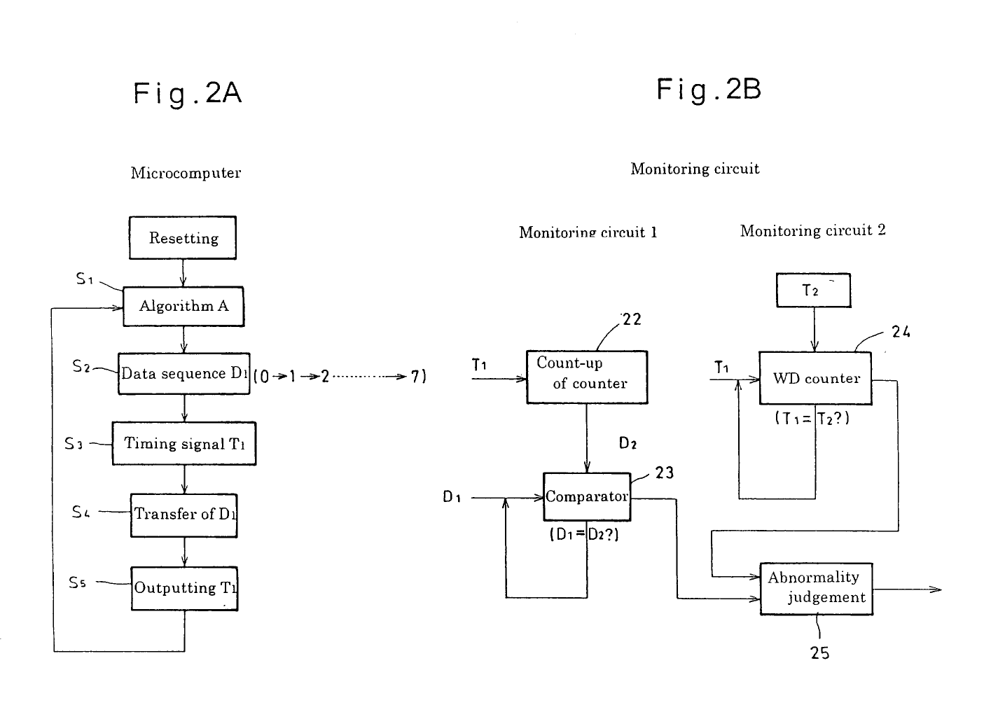

The microcomputer 10 is monitored by the monitoring circuit 20 in the following manner so that abnormality such as a failure or runaway is detected. FIG. 2A shows the operation of a program portion necessary to monitor the microcomputer in the form of a flowchart. FIG. 2B shows in the form of a functional view because the monitoring circuit 20 is a hardware.

In FIG. 2A, when the microcomputer 10 is activated, data sequence signals D₁ (0→1→2 . . . 6→7) are generated in step S₂ and corresponding timing signals T₁ are generated in step S3 at predetermined pulse intervals by the algorithm A in the program in step S₁. In step S₄, D₁ are transferred. In step S₅, T₁ are outputted. When the signals D₁ and T₁ are sent, in the monitoring circuit 20a, signals D₁ and D₂ are compared. As described above, the signals D₂ are counted up and generated from the timing signals T₁ in the counter 22. The counter 22 generates 1-, 2-, 3-family signals in three-bit counters B₁, B₂ and B_{3,} respectively, to generate a numerical sign sequence 0, 1, 2, 3 . . . 6, 7 with each digit figure of binary figures at each timing.

On the other hand, data sequence signals D₁ are sent to the register A from the microcomputer 10. When the time set by the timing signals T₁ sent to the register A has elapsed, data sequence signals D₁ are sent from the register A to the comparator 23. The time is set at a time during which the data sequence signals D₂ are generated in the counter 22. In the comparator 23, signals D₁ are compared with signals D₂. If there is any error in any of the data sequences, an abnormality signal is given to show the occurrence of an abnormal state. But if there is no abnormality, the comparator 23 will give normal signals.

In comparing data sequence signals D₁ and D₂ in the comparator 23, since the timing signals T₁ are simple ON-OFF signals and the timing sequence signals D₁ are complicated signals, the possibility of giving a normal output for abnormality is low in the detection by the signals D₁.

On the other hand, the timing signals T₁ are also sent to the WD counter 24, and it is directly detected whether the signals T₁ contain abnormality. In the WD counter 24, timing intervals T₂ that are considered normal are set to check whether or not the signals T₁ meet them. If there is any abnormality, an abnormality signal is sent to a determining portion 25. In the determining portion 25, if any abnormality is detected in either of the first monitoring circuit 20a and the second monitoring circuit 20b, it determines as abnormal and outputs an abnormality signal to outside.

As described above, in the monitoring method and circuit of this invention, when data sequence signals and timing signals from the microcomputer are received, the same data sequence signals and timing signals are generated by its own counter to compare, check and monitor whether or not the input signals are correct signals, thereby detecting abnormality of the operation of the microcomputer. Thus, detection is possible with a high level by mounting complicated signal sequences in the microcomputer. Also, because the monitoring circuit can be formed of counters, it can be manufactured at a low cost.

What is claimed is:

1. A method of monitoring a microcomputer for an onboard control device, comprising the steps of generating and outputting data sequence signals D₁ and timing signals T₁ of predetermined intervals in a control program of the microcomputer to be monitored, generating data sequence signals D₂ from the timing signals T₁ in a counter, comparing the data sequence signals D₁ with the data sequence signals D₂ to detect any abnormality of the data sequence signals D₁, and detecting abnormality of the timing signals T₁ by comparing with timing signals T₂ set by a counter, whereby monitoring the microcomputer by detection of abnormality of the data sequence signals and the timing signals.

2. A circuit for monitoring a microcomputer for an onboard control device, comprising a program provided in a control program of the microcomputer to be monitored for generating data sequence signals D₁ and timing signals T₁ of predetermined intervals, a monitoring circuit connected to the microcomputer for detecting a failure or runaway of the microcomputer to transfer said data sequence signals D₁ and said timing signals T₁, said monitoring circuit having a counter for generating data sequence signals D₂ from the timing signals T₁, a first circuit having a comparator for comparing the data sequence signals D₁ with the data sequence signals D₂ to detect abnormality of the data sequence signals D₁, and a second circuit having a counter for detecting abnormality of the timing signals themselves, and an abnormality determining unit for determining abnormality based on the detection signals of said first and second circuits.

3. A circuit for monitoring a microcomputer for an onboard control device as claimed in claim 2 wherein said data sequence signals D₁ are formed by combining signal sequences sent from an output terminal of the microcomputer in parallel in a predetermined order, and wherein the counter for generating the data sequence signals D₂ is designed to generate and send the data sequence signals from the timing signals T₁ so that they will be of the same structure as the signals D₁.

4. A circuit for monitoring a microcomputer for an onboard control device as claimed in claim 2 or 3 wherein timing signals T₂ as a reference signal are set in the counter for detecting abnormality of said timing signals T₁.
